(19) United States
(12) Patent Application Publication
(10) Pub. No.: US 2024/0268596 A1
(43) Pub. Date: Aug. 15, 2024

(54) AUTOMATIC SYSTEM FOR DISPENSING AND PRESSURE-BREWING GROUND FOOD SUBSTANCE, ESPECIALLY GROUND COFFEE, AND A METHOD OF DISPENSING AND PRESSURE-BREWING FINELY DIVIDED FOOD SUBSTANCE

(71) Applicant: AYA RAW NATURE SP. Z o.o., Warszawa (PL)

(72) Inventors: Marcin Michal PAWELCZYK, Zielona Gora (PL); Pawel SLYK, Otwock (PL)

(21) Appl. No.: 18/564,746

(22) PCT Filed: May 26, 2022
(86) PCT No.: PCT/IB2022/054941

§ 371 Date: Nov. 28, 2023

(30) Foreign Application Priority Data
May 28, 2021 (PL) 437989

(51) Int. Cl. A47J 31/36; A47J 31/46

(52) U.S. Cl. CPC A47J 31/3623; A47J 31/3609; A47J 31/46

(57) ABSTRACT

The present invention relates to an automatic system for dispensing and pressure-brewing food substance, especially ground coffee, comprising a brewing device and a replaceable container with food substance to be brewed, the brewing device being provided with a seat with means for cutting the lid of the container and adapted for receiving containers with finely divided food substance, which seat is connected to a dispensing assembly that guides the food substance through a feeder to the brewing assembly, characterized in that the brewing device comprises a dispensing assembly which is arranged horizontally with respect to the vertical axis of the seat (1) and which is provided with a feeder, preferably a screw feeder (15), actuated by a motor (8), wherein a feeder outlet (17-1) leads directly to a brewing assembly equipped with a brewing chamber (5) to which leads an assembly (23) for feeding hot pressurized water by means of a stationary rear piston (4) equipped with a shower element (22) in the form of a strainer for conveying hot water, and wherein the brewing chamber is provided with a front piston (3) actuated by a movement of the brewing chamber (5) body by means of a motor (7), which front piston (3) has a surface configured for evenly distributing hot water under the strainer (25) which has spatial embossments to improve water flow, and the front piston (3) further comprises a check valve (24), behind which there is a spout conduit (9) discharging a brewed infusion, whereas the food substance container is made of biodegradable material and preferably contains ground coffee. Furthermore, disclosed is a method of dispensing and pressure-brewing a finely divided food substance using the system defined above.

The subject of the invention is an automatic system for dispensing and pressure-brewing ground food substance, especially ground coffee, and a method of dispensing and pressure-brewing a ground food substance.

More particularly, the invention relates to a coffee dispensing and pressure-brewing system utilizing ground coffee applied from biodegradable paper containers, especially in the shape of a cup.

At present, environmental organizations are sounding an alarm, because in times of widespread use of coffee machines, capsules being utilized are a huge environmental problem. Most of them are not recyclable, and even if such a process is technically possible, such as e.g., for aluminum capsules, it is energy-consuming and requires discipline of users who should return utilized capsules for re-processing and what is something to a great extent users do not do.

At the same time, a capsule system enables miniaturization of a coffee machine, limiting its role to the delivery of hot water through a coffee capsule. As a result, capsule coffee machines are easy to build, and therefore cheap and relatively reliable. WO2012/070000A1 discloses coffee capsules, in particular Nespresso IM, which are compatible capsules that improve the performance of a product obtained by the use of a recess or concavity on the side where water and/or steam enters the capsule, thereby utilizing a radial change in the flow of water and/or steam entering along an axis parallel to the axis of the capsule.

WO2006/037062A1 discloses a liquid infusion sachet having a fluid distribution element arranged in an upper plane and a first liquid-permeable filter element, wherein the first filter element is sealed to the fluid distribution element to form a first interior chamber that contains a liquid-dispersed substance, the fluid distribution element having at least one injection nozzle protruding downward from the upper plane into the interior chamber, the injection nozzle having at least one infusion port which directs fluid into the first interior chamber in a direction that is not perpendicular to the upper plane, the first filter element comprising at least a first area and at least one second area, wherein the permeability of the first area is different from that of the second area.

The aim of the invention is to build an espresso machine offering the convenience of use similar to that of capsule coffee machines while eliminating the need to use capsules as a non-ecological, energy-consuming product that increases the cost of making the final brewed coffee.

For this purpose, the Applicants have used a pro-ecological solution utilizing finely divided food substance, preferably ground coffee, delivered from a biodegradable container, hermetically sealed in a protective atmosphere, which is used for the unit for delivering this substance to the infusion group assembly, based on a parameterized screw feeder, and a suitably designed brewing chamber in the brewing group assembly.

Thus, the subject of the invention is an automatic system for dispensing and pressure-brewing a food substance, especially ground coffee, comprising a brewing device and a replaceable container with food substance to be brewed, the brewing device being provided with a seat with means for cutting the lid of the container and adapted for receiving containers with a finely divided food substance, which seat is connected to a dispensing assembly that guides the food substance through the feeder to the brewing assembly, characterized in that the brewing device comprises a dispensing assembly which is arranged horizontally with axis of the seat and which is respect to the vertical equipped with a feeder, preferably a motor-actuated screw feeder, wherein a feeder outlet leads directly to a brewing unit provided with a brewing chamber to which leads an assembly for feeding hot pressurized water by means of a stationary rear piston equipped with a shower element in the form of a strainer for conveying hot water, and wherein the brewing chamber is provided with a front piston actuated by a movement of the brewing chamber body by means of a motor, a reverse operation of the pistons being allowed, in which the rear piston will be set in motion by means of the chamber driven by a motor and the stationary front piston, which front piston has a surface configured for evenly distributing hot water under the sieve, which has spatial embossments to improve water flow, and the front piston further comprises a check valve, behind which there is a spout conduit discharging a brewed infusion, while the food substance container is made of biodegradable material and preferably contains ground coffee.

Preferably, the automatic system for dispensing and pressure-brewing a food substance comprises a container with food substance to be brewed, which is a paper cup with ground coffee, closed at the top with a cuttable foil.

The container with food substance to be brewed is hermetically sealed in a protective atmosphere.

The brewing device comprises an automatic container opening system and the means for cutting the container lid constitute curved knives and central knives.

Furthermore, in the above device, the front piston comprises a spatially profiled sieve which is made of stainless steel, the sieve being perforated with holes in the shape of a funnel narrowing in the direction of the fluid flow, and also having a hole density of 30-50 holes per cm² of its surface; while the rear piston has means for conveying hot water in the form of a shower jet and is profiled in the upper part for even distribution of the food substance to be brewed, and has shaped zones between the strainer and the piston surface for even distribution of water to the food substance, and the brewing chamber is made of high temperature and pressure resistant plastic.

Another object of the invention is a method of dispensing and pressure-brewing a finely divided food substance using the system defined above, consisting in feeding the food substance into the system by means of a container made of biodegradable material closed with a circumferentially welded foil which is cut with knives, and fed into the system to a horizontal feeder leading to the brewing chamber, to which hot water is conveyed through the rear piston with a strainer, then pressing the front piston with a strainer towards the stationary rear piston via a body driven by a DC motor, and after that holding the front piston against the outer wall using magnets to compact the food substance and in order to fully open the brewing chamber, after which the brewing process of the food substance in the brewing chamber is started by directing the infusion obtained from the food substance through the spout to the receiving tank, and then, after the end of the brewing process, the body, pulling the front piston, is actuated again in order to press the remaining food substance residues to dry and further compact the food substance residues, after which the body retracts to open the brewing chamber, and the obtained grounds are pushed out by pressing in a linear manner the front piston against the front wall, grounds that are pushed out beyond the contour of the chamber interior falling down into the grounds container, while the entire system goes into standby mode.

After the food substance has been fed into the brewing chamber, the screw is driven by the motor to make one revolution in a direction opposite to the dispensing direction to prevent spilling of the brewed substance after the dosing is finished and to prevent the food substance from becoming airy and moist.

The system according to the invention is used for the automatic pressure-brewing of finely divided food substance, preferably ground natural coffee. The process is a synergy of the operation of capsule and automatic coffee machines, in which coffee preparation is performed similarly to an automatic coffee machine, but pre-ground coffee is used, therefore the system does not have a coffee bean grinder. At the same time, finely divided food substance, preferably ground coffee, is delivered in a loose form by means of a replaceable biodegradable container, preferably a paper cup, and is then dispensed and brewed in the brewing device, i.e., the dosing and brewing process takes place without the use of a capsule.

The invention will be illustrated below with the drawings, in which:

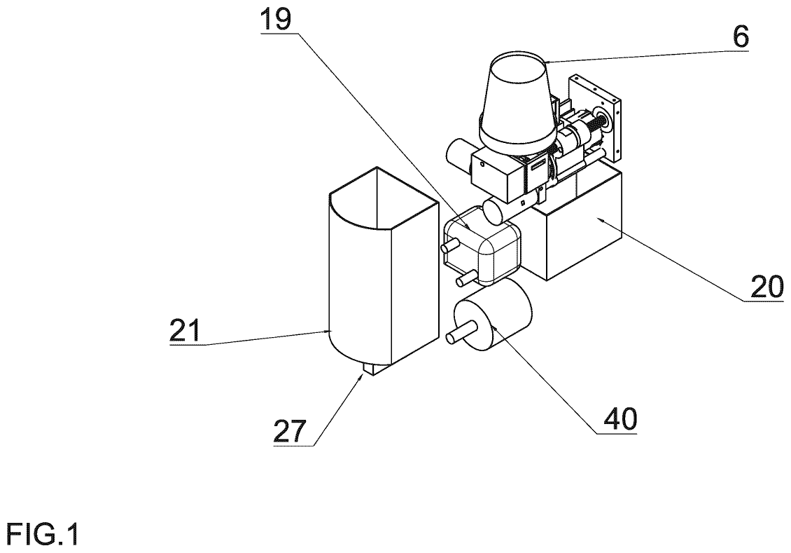

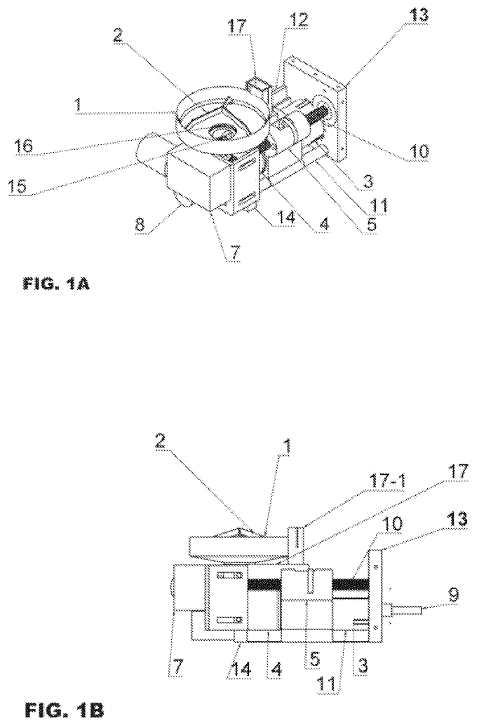

FIG. 1 shows a schematic perspective view of a dispensing and pressure-brewing system according to the invention;

FIG. 1A shows a schematic perspective view of a brewing device for the system according to the invention;

FIG. 1B is a side view of the device of FIG. 1;

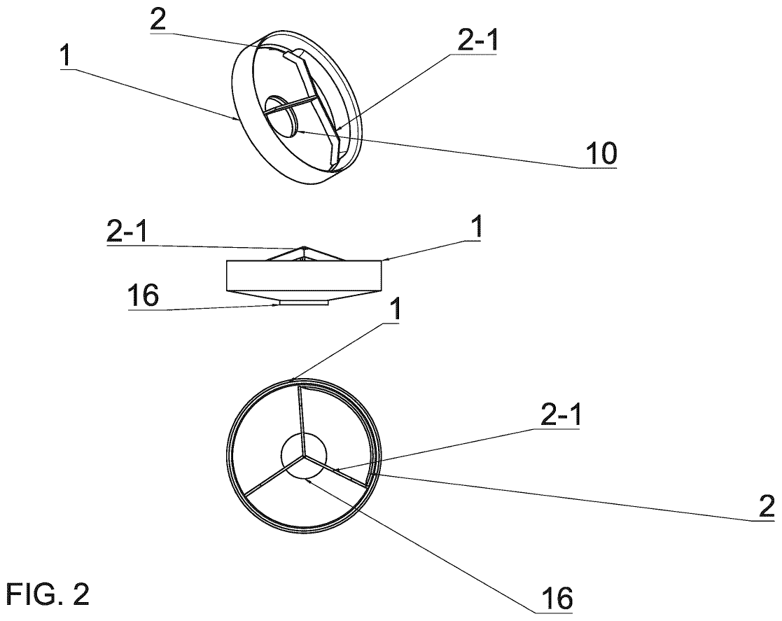

FIG. 2 shows a perspective view, a side view and a top view of a seat used in the device of FIG. 1;

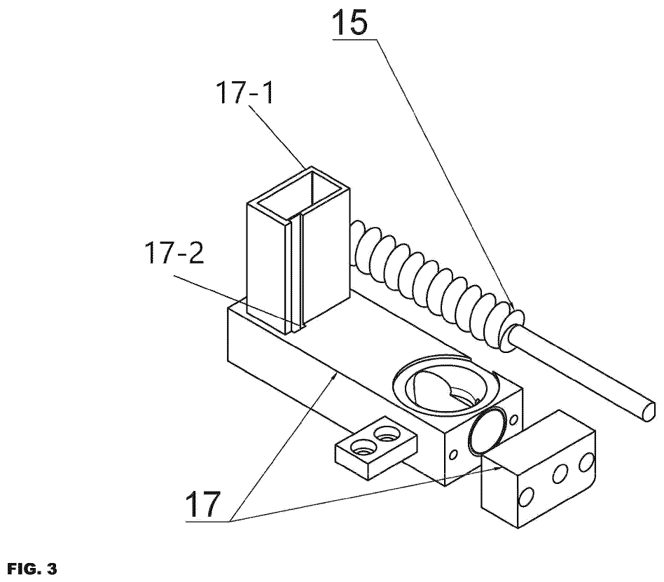

FIG. 3 shows a perspective view of a feeder body and a screw feeder;

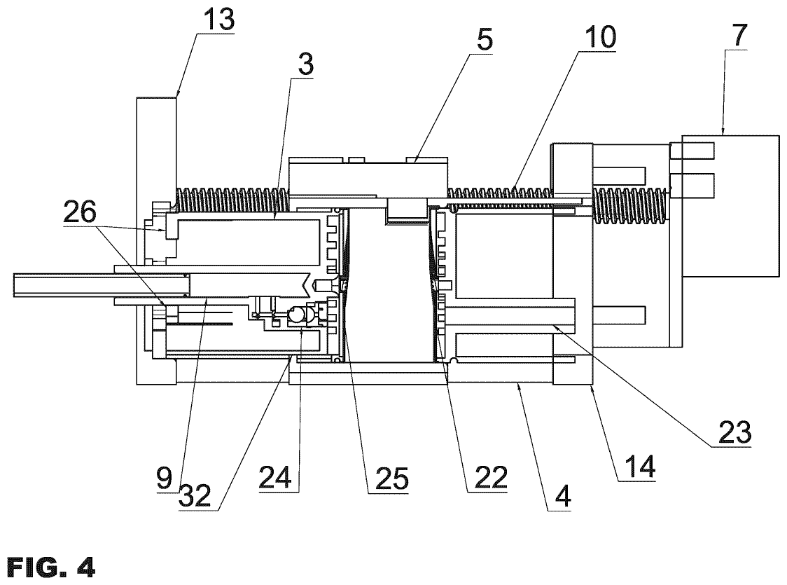

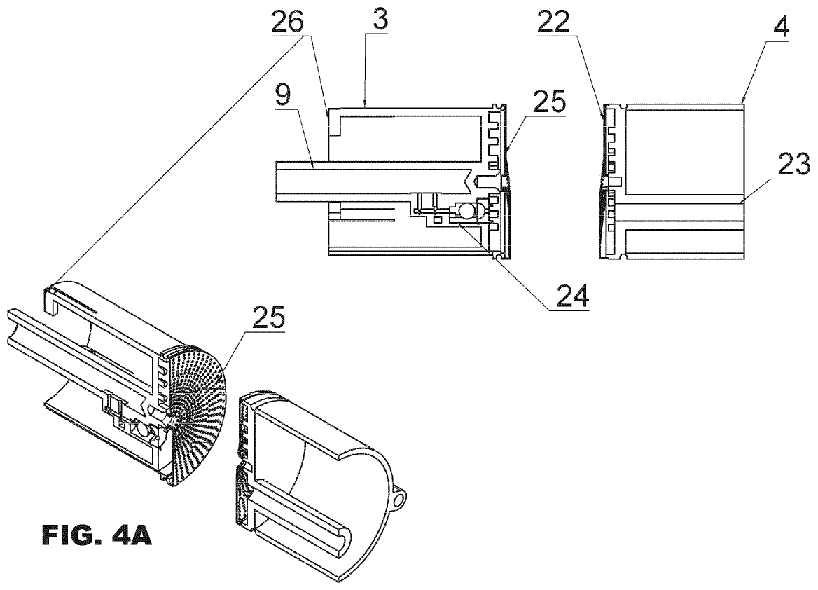

FIG. 4 shows a cross-sectional view of a brewing device and FIG. 4a shows a brewing group assembly of the device in a perspective and exploded side view;

FIG. 5 is a top view and a perspective view of a 3D Brew system profiled sieve/strainer used in the brewing group assembly of FIG. 4a;

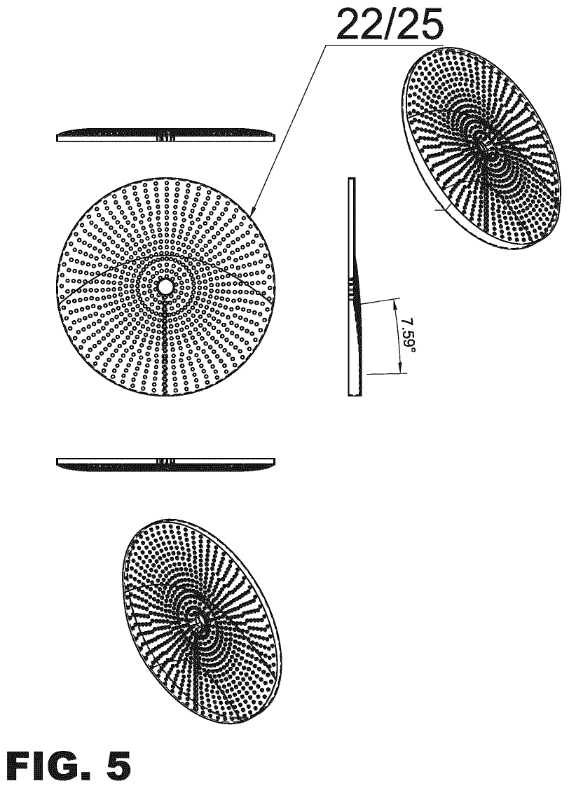

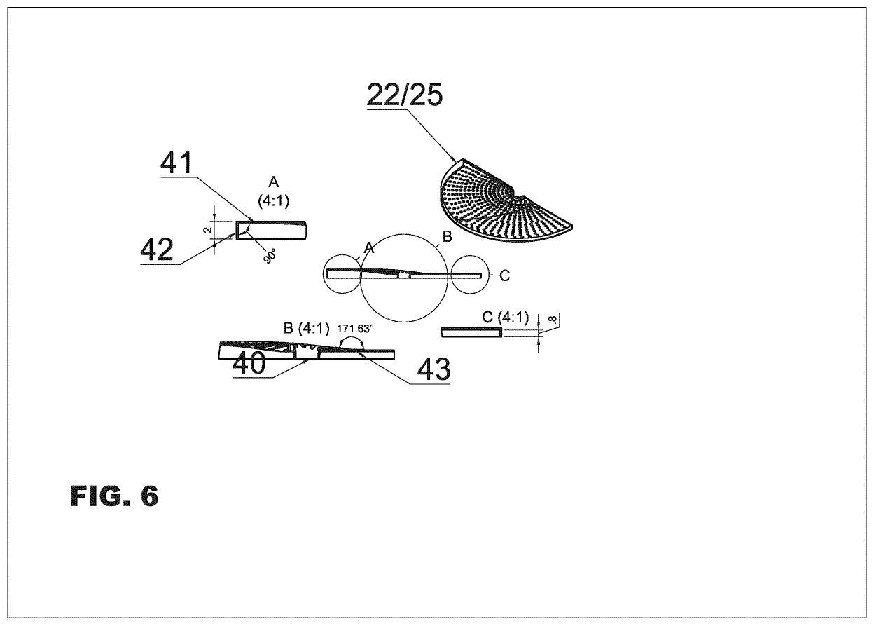

FIG. 6 shows details of the structure of the strainer of FIG. 5 in cross sections and a perspective half view;

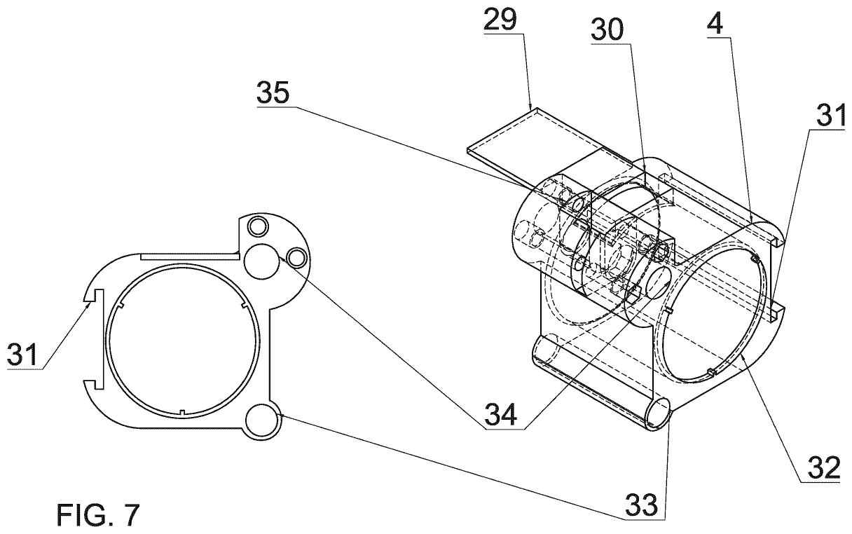

FIG. 7 is a perspective view and a cross-sectional view of a brewing chamber body used in the brewing device of FIG. 1;

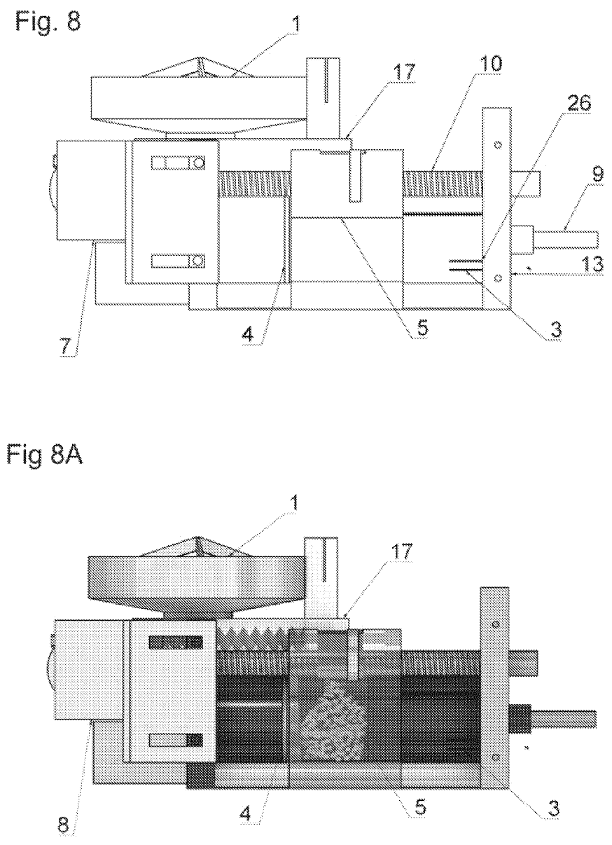

FIGS. 8 and 8a, FIGS. 9 and 9a and FIGS. 10 and 10a show the arrangement of pistons of the brewing group assembly in the various operating steps of the brewing device.

FIG. 1 illustrates a perspective view of a system for dispensing and pressure-brewing a finely divided food substance, especially ground coffee. According to the invention, the includes system a brewing device and a replaceable container with food substance to be brewed, a water container and a waste container, furthermore electric motors for driving the brewing group assembly and the dispensing screw feeder, and also a flow heater and a water pump. The container for the ground food substance is replaceable for the system according to the invention and is made of a biodegradable material, preferably paper. The container may have various horn shapes, and preferably it is cup-shaped. The cup-shaped paper container is circumferentially closed with a protective foil of barrier paper, plastic or metal foil, the closure being hermetic and is preferably made in a protective atmosphere. The ground food substance may be either coffee of various kinds and types of roast, or a Roibos tea to be brewed, but is preferably ground natural coffee.

Finely divided food substance from the container is fed to the brewing device in such a way that when the container is installed in the seat 1, it is automatically opened, i.e., the protective foil is cut by the curved knives 2 and the lid is tilted by the knives 2-1.

The brewing device comprises a seat 1 for receiving said container, equipped with means for cutting the foil of the container, consisting of knives 2-1 and curved knives 2, and a dispensing assembly arranged horizontally with respect to the vertical axis of the seat 1, the feeding assembly being provided with a screw feeder 15 which delivers the food substance to the brewing group assembly where it is brewed and the grounds are automatically ejected into the used food substance container. Further, the brewing device comprises a brewing group assembly which is constructed as a linear horizontal group consisting essentially of three elements:

a stationary rear piston 4, a brewing chamber 5 and a movable front piston 3 with a spout 9.

The piston 3 is actuated by the movement of the brewing chamber 5 through the screws 10, which in turn are actuated by the work of the DC motor 7.

FIG. 1A illustrates the structure of a brewing device which includes a food substance delivery assembly including a seat 1 with a seal 27 positioned on its upper rim. The seat comprises curved knives 2-1 and knives 2 which are arranged radially with respect to the center of the charging opening 16. Preferably, they are three knives, as shown in FIG. 1a, but further modifications of the number of these knives are also possible. Each of the knives 2 terminates on its end at the periphery of the seat 1 with a knife 2-1 which has a downwardly curved shape so as to touch the foil closing the food substance container. The brewing device further includes an assembly dispensing food substance to the brewing group assembly, which is a screw feeder 15 positioned horizontally with respect to the vertical axis of the seat 1. Further, the brewing device comprises a brewing group assembly that includes a front piston 3 with a spout 9 and a rear piston 4 and a brewing chamber 5.

FIG. 2 illustrates in more detail the structure of the seat 1 for the food substance delivery assembly, together with the knives 2, 2-1 for cutting the sealed foil of the finely divided food container.

Opening the container with ground food substance, preferably ground coffee, is performed by pressing the container against the upper rim of the seat 1 and against the silicone or rubber seal, and then turning it by 90 degrees with respect to the seat 1 axis, which causes the rim of the foil lid of the container to be incised by the knife 2, and folding back this lid with knives 2-1. After incising and folding back the foil lid, the container remains sealed in the seat chamber on the seal, and thus, after opening the container, food substance pours down in the direction of the charging opening 16 on walls profiled at an angle ranging from 15 to 40 degrees towards the center of the opening 16, which facilitates the pouring out of this substance to the screw feeder 15. Generally, the food substance feeding unit is composed of:
knives 2 and 2-1 cutting through the foil protection in the container, which enables the coffee to be poured from the container into a reservoir in the form of a seat 1 of the brewing device and further through the charging opening 16;
the seat 1 that allows the food substance container to be placed therein, provides a sealed connection and constitutes a chute for this substance to the charging opening 16;
the screw feeder 15 shown in FIG. 3, acting as a dispenser for transporting finely divided food substance from the reservoir, i.e., the seat 1 of the brewing device, to the brewing group assembly.

The funnel-shaped seat 1 performs the function of securing the coffee container, its diameter depending on the diameter of the container used and may be different depending on the solution used. The seat as a charging hopper for ground coffee directs the product to the opening 16 of the screw feeder 15, which transfers the coffee to the brewing chamber 5. The seal on the periphery of the seat 1 ensures tightness of the unit and prevents airing of the coffee in the reservoir, i.e., the cup in seat 1.

An exemplary illustration of the structure of the screw feeder 15 and its body 17 is shown in FIG. 3.

As mentioned above, an element of the food substance feeding unit is a screw feeder 15 with a diameter ranging from 9 to 20 mm and with a spacing of the feeder blades of 3 to 10 mm between them, and the height of these blades ranging from 3 to 10 mm, wherein the screw feeder 15 has a connection for a motor 8 DC 12-24V with a power of 3-10 W, thanks to which coffee is served and simultaneously fed into the brewing chamber 5.

Preferably, the screw feeder 15 is made of plastic such as Ultem, ABS and the like, or of stainless steel. Furthermore, the screw feeder 15 has a body 17 made of a material resistant to abrasion, high temperature and pressure, preferably ULTEM plastic from SABIC. This body forms a hermetic unit enabling precise dosing of food substance and protecting it against environmental influences such as airing, moisturization, etc. The body 17 of the screw 15 has an additional function of venting the chamber 17-2 after brewing and a chimney 17-1 for dispensing cleaning chemicals for coffee brewing circuits, the front piston 3, the brewing chamber 5, the rear piston 4, the spout 9, and also the sieves 22 and 25, and in the lower part it functions as a port 18 for discharging food substance into the brewing chamber 5.

The screw guide, i.e., the body 17, is made of an abrasion-resistant material and has a rectangular cross-section on the outside and a circular cross-section on the inside. In the lower front part, there is a port 18 for discharging food substance into the brewing group assembly, fitted so as to adhere exactly to the surface of the chamber 5 and the charging opening 30. A motor 8 driving the screw 15 is positioned in the rear part of the screw feeder 15. A fine pitch screw enables precise dosing of food substance and is a unit seal preventing airing of food substance.

FIG. 4 shows details of the structure of the brewing group assembly shown in cross section of the brewing device. FIG. 4a shows the structure of the brewing group assembly in exploded views. The innovative brewing group assembly is constructed as a linear horizontal group based on three basic components: the rear piston 4, the brewing chamber 5 and the front piston 3 with the spout 9.

The front piston 3 is cylindrical in shape and is a moving passive element that is driven through the housing of the brewing group assembly by means of a locking rim 32, and is provided with a strainer 25 for brewing food substance. It further has an integrated spout 9, which is constructed of two sleeves, one in the other working on the principle of a telescope, which allows the front piston to move and maintain the tightness of the spout unit, and a check valve 24 located just behind the brewing sieve 25. The sieve 25 placed in the piston has a 3D Brew brewing system—a specially made spatial embossments of the sieve 25 to improve the flow of water and the arrangement of food substance in the brewing group. Furthermore, the front piston 3 has locking magnets 26 so that the front piston remains in place magnetically fixed to the front wall 13 of the brewing device, which allows the brewing chamber 5 to be fully opened, and in the next step the thrust force of the chamber 5 pulls the front piston 3 away from the wall 13 and it follows the chamber, acting as a rammer for food substance. The rear piston 4 is also cylindrical in shape and is a stationary element permanently fixed to the rear wall 14 of the brewing device. This piston delivers boiling water onto the compacted food substance in the form of the so-called shower head through the strainer 22, profiled in the 3D Brew system. The boiling water is fed through the water connection 23 which supplies water from the water tank and is heated by an electric heater. The construction of the strainer 22 in the 3D Brew system through the so-called shower head allows even flow and distribution of water under the strainer 22, and consequently the coffee brewing process begins.

FIG. 5 shows a top view and a perspective view of the sieve 25/strainer 22 with 3D Brew System profiling that is used in the brewing group assembly. The round sieve 25/strainer 22 has a spatial profile, the sieve being ⅓ flat and ⅔ angled as shown in FIGS. 5 and 6. The sieve 25 is made of stainless steel, preferably coated with Teflon, and pressed with the outer rim 42. The structure of the sieve is such that in its lower part it is parallel to the abutment surface in the piston 3, whereas the top of the sieve is profiled at an angle of curvature in the range of 165-181 degrees, preferably 171 degrees, and broken in ⅗ surface area 43 of the sieve.

The sieve 25 is perforated with openings through which brewed food substance flows, the openings being profiled in the shape of a funnel, the cone of which is narrowing towards the direction of the fluid flow, the density of the perforation holes in the sieve being from 30 to 100 pieces per cm², preferably in the range of 30 to 50 pieces per cm², and their diameter ranges from 35 to 280 μm. The sieve 25 placed on the front piston 3 has a funnel oriented in the flow direction towards the spout 9 on the strainer 22, which in turn is placed on the rear piston 4.

On the other hand, the perforations in the strainer 22 in the form of a funnel and instead take the form of a mesh with a throughput ranging from 35 to 280 μm, so that the boiling water in the form of a shower jet is evenly distributed over the surface of the compacted food substance. The discussed profiling of the strainer 22 in the 3D Brew system improves the flow of water through the food substance being brewed, and also balances the distribution of the food substance poured into the brewing system. The strainer 22 is also made of stainless steel.

The sieve 25 and the strainer 22 are secured to the pistons, respectively, 3 and 4 by a screw through the central hole 40.

FIG. 7 shows the body of the brewing chamber 5 used in the brewing device in a perspective view and in a cross-sectional view. The body of the brewing chamber 5 is made of a pressure and high temperature resistant material, preferably a plastic selected from the group of ABS, Ultem and the like. Preferably, it is made of a material with the trade name ULTEM offered by authorized manufacturers.

The body of the brewing chamber 5 has a fin 29 that closes the inlet of food substance, a seat 30 for the pouring of food substance, a seat 31 for a guide 12 on which the body is mounted, and on its opposite wall there are seats 33 and 34 through which elements are led that stabilize and allow sliding, i.e. the seat 33 for the lower guide 11, the seat 34 for a screw propeller 10 and the seat 35 for the propeller guide 36. In addition, the above body 5 has a front piston stop 32.

The food substance inlet opening in the upper part of the body 5 is dimensionally correlated with the coffee discharge port from the screw feeder 15.

To ensure airtightness of the coffee feeder, a blocking fin 29 is used, which is located in the upper rear part of the block, and additionally, when closing the group, this fin determines the zero position for pouring coffee.

The interior of the brewing chamber 5 has the form of a cylinder and in the front part of the chamber there is a narrowing step that blocks the front piston 3.

The guide 12 is characterized by low resistance to motion with high lateral stability, ensures precise linear movement of the brewing group elements and axial operation.

FIGS. 8, 8a, 9, 9a and 10, 10a show the operation of the system for dispensing and pressure-brewing finely divided food substance, preferably ground coffee.

An exemplary system according to the invention works according to the scheme:

A container, for example in the shape of a traditional disposable paper cup, tube or of similar shape, containing a suitably ground coffee, is placed in the seat 1 and partially pours down into the seat 1. It is possible to use an automatic unit for opening the container, e.g. through incising the membrane closing the cup by specially designed knives 2 and 2-1, which incise the edges of the membrane and deflect it upwards in such a way that the coffee pours down into the charging opening 16 under the seat 1. The seat has the form of a cone depending towards the feeding chamber of the screw feeder 15. Screw feeder 15 drive is obtained from the motor 8, after the screw feeder 15 is actuated, and then it dispenses the coffee into the brewing chamber 5. Due to the special construction and the pouring of coffee into the brewing chamber 5 by means of the screw 15, it is possible to precisely dose the amount of coffee being delivered. Furthermore, due to the sealed construction of the feeder body 17, the coffee in the unit does not wet or air. Additionally, in order to keep the machine clean, after the coffee is fed into the brewing chamber 5, the screw feeder 15 makes one revolution in the opposite direction to the feeding, so that the coffee does not pour out after the dispensing process is completed, nor is it exposed to moisturization and airing.

The moving element, i.e., the body 5, is driven by a screw 10 set in rotation by means of a DC motor 7. The force with which the piston compacts the coffee is a derivative of the pressure obtained by the piston by means of the screw 10 and the body 5, and this value can be adjusted via software by measuring current draw to the motor.

The adjustment of the clamping force is based on a test, in an electronic circuit supplying power to the motor 7, of the current drawn by this motor. The increase in the value of the current in the power supply circuit of the motor 7 constitutes feedback related to the resistance on the front piston 3 caused by obtaining adequate pressure on the rear piston 4 and compaction of the coffee.

Generally, in a linear horizontal group, pouring of the coffee by gravity causes the technical disadvantage of uneven distribution of the coffee in the charging chamber. Coffee poured from the top into a vertically oriented brewing chamber will gravitationally fall to the lower part of the chamber, creating upwardly a cone. This phenomenon is disadvantageous as it will result in a non-uniform compaction of the coffee in the brewing chamber. In the lower part of the chamber, the amount of coffee will be greater and it will be compacted faster. Consequently, the degree of compaction of the coffee in the lower part of the chamber will be greater than in the upper part. To counteract this phenomenon, the Applicants have used the 3D Brewing system, which allows to compensate for the described phenomenon. The elimination of this phenomenon is achieved by appropriately shaping the brewing sieves 25 and 22, both sieves having the same profile, but having different surfaces, which improves both the compaction of the coffee and the water flow, making this flow even. As a consequence, even brewing and a better taste of the final drink are achieved.

The mechanical stability of the brewing chamber 5 is ensured by a rail 12 and a screw 11. In more demanding applications, the rail 12 may be replaced by a specialized horizontal guide.

The outer housing of the brewing chamber 5 is a movable element, set in motion by the screw 10, and the movement of the chamber housing entails the displacement of the front piston 3. The brewing chamber has an inlet opening 30 for coffee, which is adapted to the screw body 17, and an outlet shutter 29, which ensures tightness of the screw body 17 unit during coffee brewing. In addition to the threaded seat 34, which is the drive transmission of the drive screw 10, the group has a second seat, which is smooth and constitutes a slide stabilizer 11, and a seat of a stabilizing bar 31 for the guide 12.

The rear piston 4 has an additional built-in seat 23 of the unit for the delivery under pressure of hot water flowing through the heater, which supplies steam to the closed unit for sterilization and cleaning of the unit. The specially designed surface of the piston 3 allows even distribution of water under the strainer 22 thanks to the 3D Brewing system. The front piston 3 comprises a sieve 25 with a 3D Brewing system and a check valve 24.

This valve constitutes a system with a glass ball and a spring providing a flow blockage up to 5 bar, which ensures better coffee brewing parameters. Downstream of the check valve 24 there is a spout conduit 9 which discharges the brewed infusion into the user's mug/cup.

The operating phases of the brewing device are as follows:

According to FIG. 8a, the motor 7, through the screw 10, sets in motion the brewing chamber 5, which is coupled to the front piston 3 and pulls it linearly in the direction of the piston 4, forming the brewing chamber 5 in a position ready for pouring coffee, the so-called position 0.

An appropriately set dose of ground coffee is taken from the hopper and, by means of the screw feeder 15, enters the brewing chamber 5.

The subsequent actuation of the motor 7 continues the path of the brewing chamber 5 and the piston 3, reducing the space between the pistons 3 and 4, and simultaneously pressing the coffee inside and forming it into an even disc—this is the coffee compacting stage, i.e., a preparatory stage for the proper brewing of coffee.

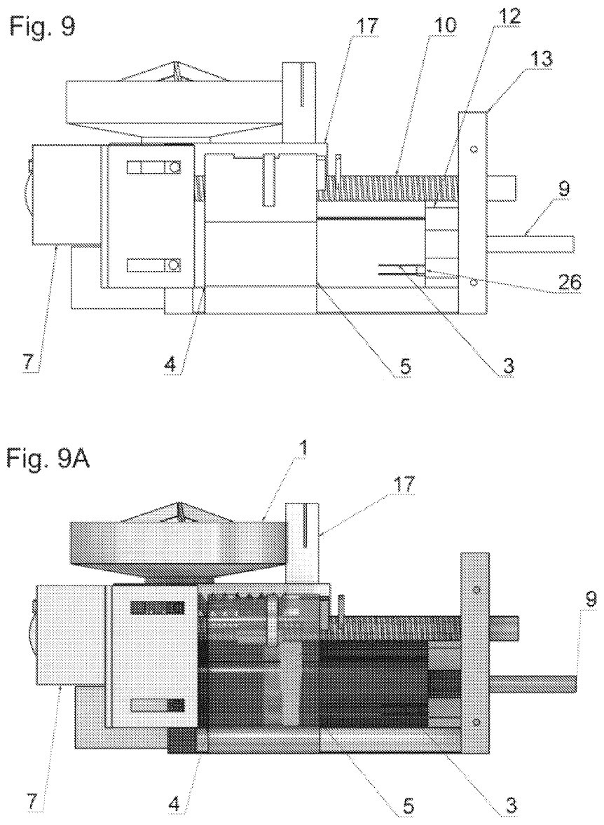

According to FIG. 9a, when the required degree of compaction of the coffee is achieved, which is measured by examining the current draw of the motor 7, the movement is stopped. The brewing process begins—that is, the high pressure pump 40 is turned on, which supplies water heated to a temperature close to boiling by the heater 19;

The brewing process begins—that is, the high pressure pump 40 is turned on, which feeds water through the flow meter 45, heated to a temperature close to boiling by the heater 19;

Water flows through the brewing group assembly with the brewing chamber 5 and consequently through the poured coffee, and the resulting brew is drained into the spout 9 and then into the user receptacle provided; After the coffee brewing process is complete, the motor 7 still works to press the piston 3 against the piston 4 in order to squeeze the water out of the coffee grounds.

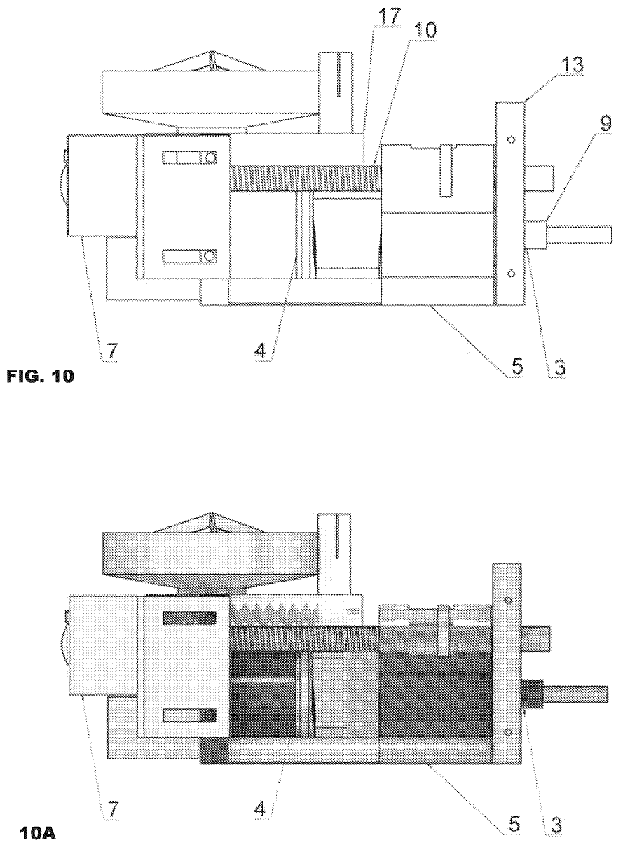

According to FIG. 10a, the motor starts to run in a reverse direction, which has the effect of opening the brewing chamber 5 until the piston 3 is pressed against the wall 13 of the brewing group assembly and the end position is reached;

The pressure against the wall of the piston 3 pushes coffee grounds out of the brewing chamber 5, which results in their removal from the brewing chamber and ejection into a waste container. In addition, a scraper 28 is provided to assist the ejection of coffee grounds and to clean the sieve 25 of the piston 3, because during the operation of the system, coffee residues remain on this sieve after brewing due to the sticking of an entire lump.

### LIST OF REFERENCE NUMERALS

1 seat;
2 curved knives;
2-1 knives;
3 front piston;
4 rear piston;
5 brewing chamber;
6 food substance container;
7 DC motor;
8 screw drive motor;
9 spout;
10 screw;
11 lower guide;
12 guide;
13 front wall;
14 rear wall;
15 screw feeder;
16 charging opening;
17 screw body
17-1 dispensing chimney,
17-2 chamber venting;
18 discharging port;
19 heating element;
20 grounds container;
21 water tank;
22 strainer;
23 water connection;
24 check valve;
25 sieve;
26 locking magnets;
27 water flow meter;
28 grounds scraper;
29 fin;
30 charging seat;
31 guide seat;
32 locking rim;
33 lower guide seat;
34 drive screw seat;
35 screw guide seat;
40 water pump;
41 profiled openings;
42 sieve outer rim;
43 break surface;

1. Automatic system for dispensing and pressure-brewing a food substance, especially ground coffee, comprising a brewing device and a replaceable container with food substance to be brewed, the brewing device being provided with a seat with means for cutting the lid of the container and adapted for receiving containers with finely divided food substance, and which seat is connected to a dispensing assembly that guides the food substance through a feeder to the brewing assembly, characterized in that the brewing device comprises a dispensing assembly which is arranged horizontally with respect to the vertical axis of the seat, and which is provided with a feeder, preferably a screw feeder, actuated by a motor,
wherein a feeder outlet leads directly to a brewing assembly equipped with a brewing chamber to which leads an assembly for feeding hot pressurized water by means of a stationary rear piston equipped with a shower element for conveying hot water,
and wherein the brewing chamber is provided with a front piston actuated by a movement of the brewing chamber body by a motor, which front piston has a surface configured for evenly distributing hot water under the strainer which has spatial embossments to improve water flow, and the front piston further comprises a check valve, behind which there is a spout conduit discharging a brewed infusion,
whereas the food substance container is made of biodegradable material and preferably contains ground coffee.

2. Automatic system for dispensing and pressure-brewing a food substance according to claim 1, characterized in that the container with food substance to be brewed is a paper cup with ground coffee, closed at the top with a cuttable foil.

3. Automatic system for dispensing and pressure-brewing food substance according to claim 1, characterized in that the container with food substance to be brewed is hermetically sealed in a protective atmosphere.

4. Automatic system for dispensing and pressure-brewing food substance according to claim 1, characterized in that the brewing device comprises an automatic container opening system and the means for cutting the container lid constitute curved knives and central knives.

5. Automatic system for dispensing and pressure-brewing food substance according to claim 1, characterized in that the front piston comprises a spatially profiled sieve which is made of stainless steel, the sieve being perforated with holes in the shape of a funnel narrowing in the direction of the fluid flow, and also having a hole density of 30 holes per cm² of its surface.

6. Automatic system for dispensing and pressure-brewing food substance according to claim 1, characterized in that the rear piston has means for conveying hot water in the form of a shower jet and is profiled in the upper part for even distribution of the food substance to be brewed, and has shaped zones between the strainer and the piston surface for better finishing brewing and the formation of foam from the food substance being brewed.

7. Automatic system for dispensing and pressure-brewing food substance according to claim 1, characterized in that the brewing chamber is made of high temperature and pressure resistant plastic.

8. Method of dispensing and pressure-brewing a finely divided food substance using the system defined by claim 1, consisting in feeding the food substance into the system by a container made of biodegradable material closed with a circumferentially welded foil which is cut with knives
and feeding to a horizontal feeder leading to the brewing chamber, to which hot water is conveyed through the rear piston with a strainer, then pressing the front piston with a strainer towards the stationary rear piston via a body driven by a DC motor, and after that holding the front piston against the outer wall using magnets to compact the food substance and in order to fully open the brewing chamber, after which the brewing process of the food substance in the brewing chamber is started by directing the infusion obtained from the food substance through the spout to the receiving tank, and then,
after the end of brewing, the piston is actuated again in order to press the remaining food substance residues to dry and further compact the grounds, after which the piston retracts to open the brewing chamber, and the obtained grounds fall down into the grounds container, while the entire system goes into standby mode.

9. Method according to claim 8, characterized in that after the food substance has been fed into the brewing chamber, the screw is driven by the motor to make one revolution in a direction opposite to the dispensing direction to prevent spilling of the brewed substance after the dosing is finished and to prevent the food substance from becoming airy and moist.
